(19) United States
(12) Patent Application Publication
(10) Pub. No.: US 2009/0092764 A1
(43) Pub. Date: Apr. 9, 2009

(54) METHOD AND APPARATUS FOR SIMULTANEOUS SPRAY AND CURE INITIATION OF CURABLE POLYMER COATING COMPOSITIONS

(76) Inventor: Leslie A. Hoeckelman, O'Fallon, MO (US)

Correspondence Address: HUGH P. GORTLER, 23 Arrivo Drive, Mission Viejo, CA, 92692, US

(21) Appl. No.: 11/868,436

(22) Filed: Oct. 5, 2007

(51) Int. Cl. C08F 2/48; B05C 11/00

(52) U.S. Cl. 427/508; 118/642

(57) ABSTRACT

Methods and apparatus are provided for simultaneously spraying an ultraviolet (UV)-curable polymer-based coating and initiating a cure process. The apparatus includes a spray nozzle, at least one radiation emitter and a power source. The at least one radiation emitter is configured to emit UV radiation at a frequency corresponding to a radiation frequency for curing a UV-curable polymer of a coating composition. The at least one radiation emitter is associated with the spray nozzle and is aligned to direct UV radiation into a mist emitted from the spray nozzle, when in use. The power source supplies power to the at least one radiation emitter. The method permits irradiation of a mist of coating composition as it exits the spray nozzle thereby initiating the production of free radicals from a photo-initiator and commencing the cure process.

### TECHNICAL FIELD

The embodiments described herein generally relate to spayed-on chemical coatings, and more particularly relates to sprayed-on coatings that are curable with radiation.

### BACKGROUND

Coating technology continues to advance to meet consumer, environmental and safety needs. For example, modern coatings minimize the use of solvents in order to reduce solvent vapor and in commercial coating operations, solvent vapors are often condensed and recovered. Efforts are also being devoted to producing coatings that are free of chromates that have been identified as environmentally suspect.

Polymer compositions that include a photo-initiator, stimulated by an appropriate wave length of ultraviolet radiation (UV) to produce free radicals, are commonly used in a variety of coatings. Once the photo-initiator has been activated to produce free radicals, the free radicals cause polymerization of the polymers of the coating composition, often referred to as “curing.” Upon cure, the polymers of the composition crosslink to form a hard surface coating. These coatings usually include additives and pigments. Polymer-based UV-curable coating compositions can be formulated as 100% solids, i.e., they may be formulated free of any solvents. This is a major advantage because solvents do not have to be captured and recycled. As a result, the workplace environment does not require all the facilities necessary for purposes of solvent recapture.

In general, these polymer-based coatings may be applied in any of a variety of methods, including for example, painting onto a surface, spray coating, dip coating, etc. In the aerospace industry, UV curable polymer coatings are often used. Depending upon the application, these coatings should meet specific requirements. For example, if the coating is to be applied to an aircraft exterior, it should be resistant to commonly encountered chemicals such as de-icing fluids, salt spray, fuel and other oils and greases. Further, the coating should be weather resistant for a reasonable life span. The coating composition should adhere well to the aircraft surface and once cured, the coating should exhibit some flexibility and not separate readily from the surface as it expands or contracts with temperature variations.

In general, when a UV curable coating is to be applied, the operator will add a photo-initiator to the coating mixture prior to application of the coating to the surface to be coated, if it has not already been added. After the coating has been applied, the coated surface is then exposed to UV light from a lamp or other source of such radiation. Consequently, significant polymer cure commences only after the coating has been applied to the surface and UV radiation is applied. This post-coating commencement of the cure process results in a time delay that could be avoided if cure were to commence earlier. Further, in certain coatings, the UV radiation may cause rapid curing at the coating surface but underlying areas of the coating may not be directly subject to the radiation and may cure at a slower rate. This leads to a longer overall cure time to ensure appropriate cure throughout the coating depth.

### BRIEF SUMMARY

In an exemplary embodiment there is provided an apparatus for simultaneously spraying a UV-curable polymer-based coating and initiating a cure process. The apparatus includes a spray nozzle, at least one radiation emitter and a power source. The at least one radiation emitter is configured to emit UV radiation at a frequency corresponding to a radiation frequency for curing a UV-curable polymer of a coating composition. The at least one radiation emitter is associated with the spray nozzle and is aligned to direct UV radiation into a mist emitted from the spray nozzle, when in use. The power source supplies power to the at least one radiation emitter.

In another exemplary embodiment there is provided an apparatus for applying a coating that includes a photo-initiator. The apparatus includes a spray nozzle configured for spraying therethrough a mist of a coating composition, and a UV emitter configured to emit radiation in a UV frequency range at sufficient power to initiate cure of a UV-curable polymer of a coating. The UV emitter is aligned to direct UV radiation into a mist of a coating composition when a mist of such coating composition exits from the nozzle. Further, the apparatus includes a power source supplying power to the UV emitter.

Another exemplary embodiment provides a method of applying a coating of a coating composition that includes a photo-initiator. The method includes the steps of selecting a coating composition comprising a UV photo-initiator, expelling the coating composition from a nozzle to form a mist of the coating composition, irradiating the mist to initiate cure of the coating composition, coating a surface to be coated after irradiating to initiate cure, and continuing to cure the coating on the surface with UV radiation.

### BRIEF DESCRIPTION OF THE DRAWINGS

Various embodiments will hereinafter be described in conjunction with the following drawing figures, wherein like numerals denote like elements, and

FIG. 1 is a schematic diagram of an embodiment of an apparatus including a spray gun with UV LED emitters;

FIG. 2 is a schematic diagram of another embodiment of an apparatus including a spray gun with UV LED emitters;

FIG. 3 is a schematic diagram of an embodiment of an apparatus including a spray gun with UV light output lenses;

FIG. is a schematic diagram of another embodiment of an apparatus including a spray gun with UV light output lenses; and

FIG. 5 is an embodiment of a process flow diagram.

### DETAILED DESCRIPTION

The following detailed description is merely exemplary in nature and is not intended to limit the described embodiments or the application and uses of the described embodiments. Furthermore, there is no intention to be bound by any expressed or implied theory presented in the preceding technical field, background, brief summary or the following detailed description.

Since one of the issues encountered with curing coatings is the difference in cure rate between curing at the coating surface exposed to the UV radiation, and cure rate at a depth below the coating's surface, it is desirable to develop an apparatus and process that permits more uniform cure rates throughout the coating thickness. This should minimize overall coating cure time. In addition, it is desirable that the UV cure commence as soon as possible during application of the curable polymer-based coating material, for example simultaneously during application of the coating with a spray gun.

In general, a UV-curable coating composition as described here includes an oligomer in the 400 to 7000 MW range that imparts many of the properties of the final coating. It also includes a monomer that influences viscosity, cure speed and some film or coating properties. It further includes pigments and additives (adhesion promoters, fillers, wetting agents, UV light absorbers to protect the finished coating from UV damage, etc.). Importantly, the composition includes a photo-initiator that absorbs UV radiation and generates free radicals that initiate polymerization and hardening or “cure” of the coating. Curing generally requires high intensity UV radiation in the wavelength range about 200-400 nm. In the specification and claims a “UV-curable” in reference to a polymer composition or coating composition means a composition that includes a photo-initiator that produces free radicals, which facilitate polymer cross linking, upon exposure of the photo-initiator to an appropriate frequency and intensity of UV radiation.

In embodiments presented, cure of the coating compositions commences as the coating composition is sprayed onto a surface to be coated. The spray or mist of coating composition exiting a spray nozzle is subjected to an appropriate UV radiation to initiate the cure process. Once the coating is applied, curing may continue with application of UV radiation at lower levels of intensity than might otherwise be necessary. Further, because cure has been initiated throughout the coating depth, cure may continue at a more uniform rate throughout the coating thickness.

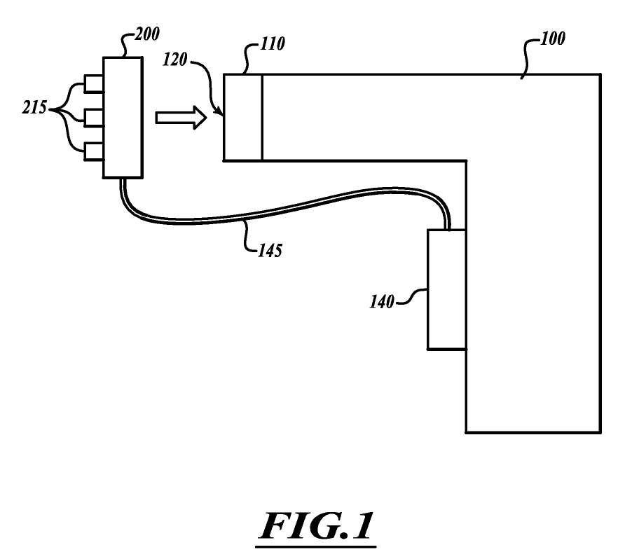

FIG. 1 illustrates in simplified form the components of an exemplary embodiment that includes a spray gun 100 with an end cap 110 and ring-shaped UV radiation emitter 200 configured to fit around the end cap 110. As used in the specification and claims, the term “UV radiation emitter” is not restricted to devices that are sources of UV radiation, but includes any device that emits UV radiation even if the UV radiation is transmitted to that device from another source of the radiation. In this embodiment, the UV radiation emitter includes a plurality of light emitting diodes (“LEDs”) 215 that emit UV frequency radiation, and that are configured to direct UV radiation into a spray or mist of coating composition exiting from the nozzle 120 of the spray gun 100. In this exemplary embodiment, the LEDs 215 are powered by a battery pack (with associated electronics) 140 that is associated with, and in this case attached to, the spray gun 100. Power may conveniently be supplied from the battery pack 140 to the LEDs via an electrical cable 145 or by any suitable means.

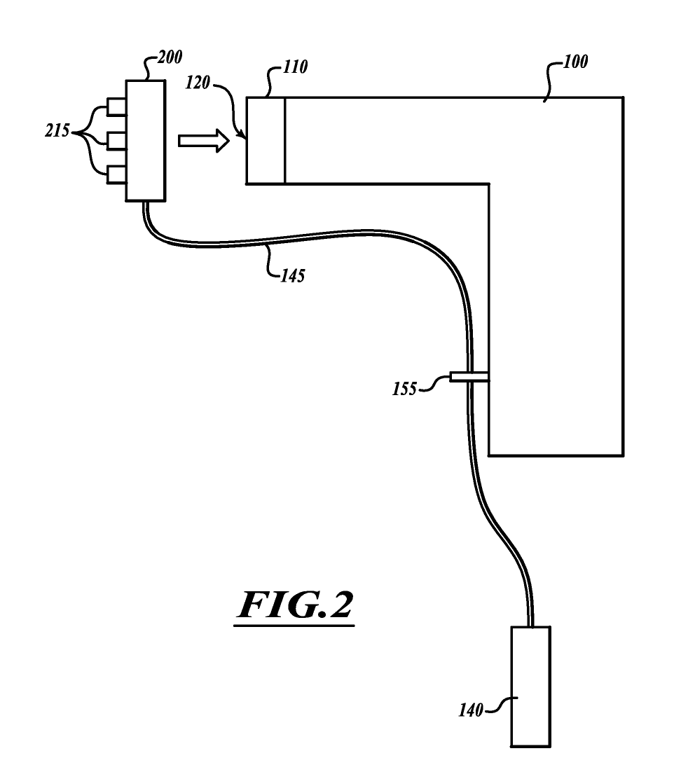

In the event that it is not convenient to have the power source attached to the spray gun, FIG. 2 illustrates an alternative example of an embodiment where the battery pack 140 is remote from the spray gun 100. A cable 145 transmits power from remote source battery pack 140 to the LEDs 215. For operator convenience, the cable 145 may be releasably or otherwise attached to the spray gun 100 at some convenient point of attachment 155.

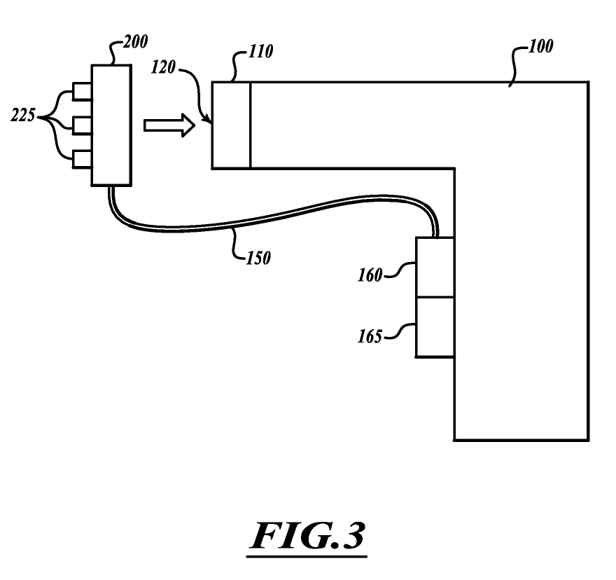

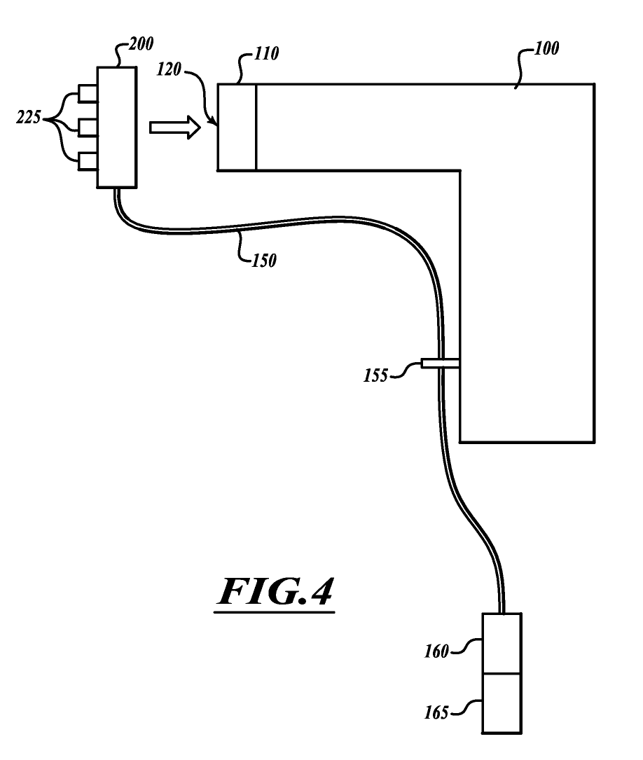

FIG. 3 illustrates a further exemplary embodiment wherein the ring-shaped UV radiation emitter 200 configured to fit around end cap 110 includes a plurality of output lenses focused to direct UV radiation into the spray or mist of coating composition exiting from the spray gun 100. In this example, the source of UV radiation 160 and the power source (battery pack 165) are both associated with the spray gun 100. The UV radiation is transmitted from source 160 to the output lenses 225 via an optical fiber 150. While the result of using output lenses focusing UV radiation may be the same as using LEDs that provide UV radiation directly, there may be operational reasons to select one version or embodiment over the other in particular circumstances.

FIG. 4 illustrates an alternative embodiment wherein the battery pack 165 and the UV source 160 are both remote from the spray gun 100. However, for operator convenience, the optical fiber 150 may be attached to the spray gun 100 at some point of attachment 155.

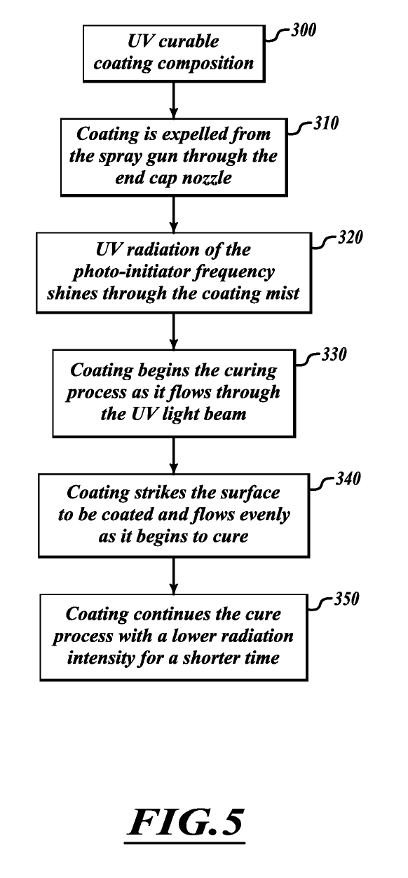

An exemplary embodiment of a process for simultaneous spraying and cure-initiation is illustrated in FIG. 5. The UV-curable coating composition is prepared or selected in step 300. After the ordinary preliminary steps of spray coating, the coating is drawn into the spray gun and expelled from the end cap nozzle of the spray gun under pressure as a mist of coating composition in process 310. Virtually simultaneously, the UV emitters irradiate the mist of coating composition with UV radiation at the desired frequency for the photo-initiator of the coating composition, in process 320. In process 330 curing commences in the sprayed mist as it passes through the UV radiation. The composition then strikes the surface to be coated and flows evenly across the surface as curing continues, in process 340. The cure process then continues with potentially lower UV radiation intensity for a shorter time period, in process 350, than if there had been no irradiation of the spray mist. The continuing provision of UV radiation onto the coating to complete the cure process may be from UV lamps or other equipment.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the described embodiments in any way. Rather, the foregoing detailed description will provide those skilled in the art with a convenient road map for implementing the exemplary embodiment or exemplary embodiments. It should be understood that various changes can be made in the function and arrangement of elements without departing from the scope as set forth in the appended claims and the legal equivalents thereof.

What is claimed is:

1. An apparatus for simultaneously spraying an ultraviolet (UV)-curable polymer-based coating composition and initiating a cure process, the apparatus comprising:
a spray nozzle;
at least one radiation emitter configured to emit UV radiation at a frequency suitable for curing a UV-curable polymer of a coating composition, the at least one radiation emitter associated with the spray nozzle and aligned to direct UV radiation into a mist emitted from the spray nozzle, when in use; and
a power source supplying power to the at least one radiation emitter.

2. The apparatus of claim 1, wherein the spray nozzle is associated with a spray gun.

3. The apparatus of claim 1, wherein the at least one radiation emitter comprises a plurality of light emitting diodes (LEDs) arrayed around the spray nozzle.

4. The apparatus of claim 3, wherein the spray nozzle is associated with a spray gun and the power source comprises a battery pack associated with the spray gun.

5. The apparatus of claim 1, wherein the at least one radiation emitter comprises an optical fiber transmitting UV radiation from a UV source to an output lens associated with the spray nozzle, the output lens aligned to direct UV radiation into a mist of a coating composition emitted from the spray nozzle during use.

6. The apparatus of claim 5, wherein the spray nozzle comprises a spray nozzle of a spray gun, and the power source and UV source are associated with the spray gun.

7. The apparatus of claim 5, wherein the spray nozzle comprises a spray nozzle of a spray gun, the power source is associated with the spray gun, and the UV source is remote from the spray gun.

8. An apparatus for applying a coating composition comprising an ultraviolet (UV)-curable polymer, the apparatus comprising:
a spray nozzle configured for spraying therethrough a mist of the coating composition;
a UV emitter configured to emit radiation in a UV frequency range at sufficient power to initiate cure of a UV-curable polymer of a coating composition, the UV emitter aligned to direct UV radiation into a mist of a coating composition when a mist of such coating composition exits from the spray nozzle; and
a power source supplying power to the UV emitter.

9. The apparatus of claim 8, wherein the UV emitter comprises a plurality of light emitting diodes (LEDs) arrayed around the spray nozzle.

10. The apparatus of claim 8, wherein the spray nozzle is associated with a spray gun and the power source comprises a battery pack associated with the spray gun.

11. The apparatus of claim 8, wherein the UV emitter comprises an optical fiber transmitting UV radiation from a UV source to an output lens associated with the spray nozzle, the output lens aligned to direct UV radiation into a mist of a coating composition emitted from the spray nozzle during use.

12. The apparatus of claim 11, wherein the spray nozzle comprises a spray nozzle of a spray gun, and the power source and UV source are associated with the spray gun.

13. The apparatus of claim 11, wherein the spray nozzle comprises a spray nozzle of a spray gun, the power source is associated with the spray gun, and the UV source is remote from the spray gun.

14. A method of applying a coating comprising a photo-initiator to a surface, the method comprising:
selecting a coating composition comprising a photo-initiator;
expelling the coating composition from a nozzle to form a mist of the coating composition;
irradiating the mist to initiate production of free radicals by the photo-initiator of the coating composition;
coating the surface with the irradiated mist; and
continuing to cure the coating on the surface with UV radiation.

15. The method of claim 14, wherein the expelling step from a nozzle comprises expelling from a nozzle of a spray gun.

16. The method of claim 14, wherein the irradiating step comprises irradiating with radiation in a ultra-violet frequency.

17. The method of claim 14, wherein the step of coating of the surface comprises coating with a mist of a coating composition that has begun to cure.

18. The method of claim 14, wherein the continuing to cure step comprises continuing to cure by applying UV radiation.

19. The method of claim 14 wherein the irradiating step comprises irradiating with UV radiation emitted from an array of light emitting diodes.

20. The method of claim 14, wherein the irradiating step comprises irradiating with UV radiation produced by a source, transmitted by optical fiber and focused through output lenses into the mist.
